(19) United States
(12) Patent Application Publication
(10) Pub. No.: US 2014/0350717 A1
(43) Pub. Date: Nov. 27, 2014

(54) ORDER FULFILLMENT METHOD

(71) Applicants: Eric E. Dagle, Grand Rapids, MI (US); Gregg A. Vanden Bosch, Grand Rapids, MI (US); Christopher J. Musson, Shanghai (CN); Steven J. Darroch, Auckland (NZ)

(72) Inventors: Eric E. Dagle, Grand Rapids, MI (US); Gregg A. Vanden Bosch, Grand Rapids, MI (US); Christopher J. Musson, Shanghai (CN); Steven J. Darroch, Auckland (NZ)

(73) Assignee: Dematic Corp., Grand Rapids, MI (US)

(21) Appl. No.: 14/247,701

(22) Filed: Apr. 8, 2014

Related U.S. Application Data
(60) Provisional application No. 61/827,401, filed on May 24, 2013.
(60) Provisional application No. 61/858,245, filed on Jul. 25, 2013.
(60) Provisional application No. 61/827,394, filed on May 24, 2013.

(51) Int. Cl. B65G 1/137

(52) U.S. Cl. CPC B65G 1/1373
USPC 700/216

(57) ABSTRACT

An order fulfillment method and order fulfillment system includes picking items from inventory according to orders for the items and placing the picked items into picked receptacles. The picked receptacles are forwarded to an unloading station where an identifier of each item is identified at the unloading stating and the identifier of the item married with the transport receptacle into which the item is placed. The transport receptacles are tracked from the unloading station according to the identifier of the item in that transport receptacle and movement of the transport receptacle. This may be accomplished by unloading items to a sorter having sorter locations. Each of the locations has a unique machine location identification. Items are placed from the picked receptacles to the sorter at one of the locations and an item identification is referenced with the machine location identification of the location at which that item is placed on the sorter. The item is diverted at a particular one of the machine locations to a particular one of a plurality of processing stations according to an order for the item that is at that machine location. The divert is by selecting that item to be diverted according to machine location identification. The item is combined with the order for that item at the processing station.

### CROSS REFERENCE TO RELATED APPLICATIONS

This application claims priority from U.S. patent application Ser. No. 61/827,401, filed on May 24, 2013; U.S. patent application Ser. No. 61/858,245, filed on Jul. 25, 2013; and U.S. patent application Ser. No. 61/827,394, filed on May 24, 2013, the disclosures of which are hereby incorporated herein by reference in their entirety.

### BACKGROUND OF THE INVENTION

The present invention is directed to an order fulfillment method and a system for carrying out such method and, in particular, to such method and system that is useful for processing a large number of orders in a relatively short period of time.

Order fulfillment of orders placed over the Internet must take place within a relatively short period of time in order to be commercially competitive. The same could be said for orders received by phone, facsimile or by the mail based on catalog or television-based merchandizing. Such order fulfillment is known as E-commerce and places demands on an order fulfillment system to meet such obligations. This is compounded by the fact that E-commerce usually involves a large number of small orders (each containing as few as one item in the order) that are selected from a large number of potential items. Each unique item has a specific inventory identification, known in the industry as a stock-keeping unit (SKU). Each item usually bears an optical code, such as a bar code or radio frequency identification (RFID) tag that identifies the SKU of the item.

Because of the large number of SKU's from which an order may be selected, the inventory warehouse may be very large in footprint. As such, it is common to designate geographic portions of the inventory warehouse to each be picked by an individual picker such that each picker picks only a portion of each order, since each order may be spread out over the entire general footprint of the inventory warehouse. Each picker is directed by a warehouse management system to pick portions of a number of orders using a various picking technology known in the art. It is efficient to have the picker mix several orders in one picking or picked receptacle rather than having multiple receptacles, each bearing one order portion. Also, each order may be contained in a number of picked receptacles if the order contains more than an individual item. However, it is then necessary to subsequently sort the contents of the picked receptacle(s) to the order and to process the items so that they can be packed-out for shipment via courier. Also, orders may be made up of items having various physical characteristics such that some items are not able to be readily handled by a conventional material-handling system. Such items are known as non-conveyable.

### SUMMARY OF THE INVENTION

The present invention is directed to a fulfillment method and system that is useful in performing the method that is especially adapted to meet the extreme demands for use in E-commerce, although it may find application to phone-based and mail-order based fulfillment as well.

An order fulfillment method, according to an aspect of the invention, includes picking items from inventory according to orders for the items and placing the picked items into picked receptacles. The picked receptacles are forwarded to an unloading station and placed items into transport receptacles. An identifier of each item is identified at the unloading stating and the identifier of the item married with the transport receptacle into which the item is placed. The transport receptacles are tracked from the unloading station according to the identifier of the item in that transport receptacle and movement of the transport receptacle. The transport receptacles are tracked to a particular one of a plurality of processing stations according the identifier of the item in that transport receptacle and an order for the item. Each item is combined with an order for that item at the particular processing station. The transport receptacles may not bear unique receptacle identifiers.

An order fulfillment method and order fulfillment system, according to another aspect of the invention, includes picking items from inventory according to orders for the items and placing the picked items into picked receptacles. The picked receptacles are forwarded to a sorter having sorter locations. Each of the locations has a unique machine location identification. Items are placed from the picked receptacles to the sorter at one of the locations and an item identification is referenced with the machine location identification of the location at which that item is placed on the sorter. The item is diverted at a particular one of the machine locations to a particular one of a plurality of processing stations according to an order for the item that is at that machine location. The divert is by selecting that item to be diverted according to machine location identification. The item is combined with the order for that item at the processing station.

The combining may be by tracking the item from the sorter to the particular one of the processing stations and matching that item with the order according to the machine location identification from which it was diverted. It may be verified that the item is the one corresponding to the machine location identification from which it was diverted by displaying an image of the item at the machine location identification corresponding to the item. The combining may be by identifying the item at the processing station and matching that item with the order according to the item identification. The identifying of the item may be by scanning an optical code on the item.

Items may be placed directly to carriers of the sorter, each of the carriers being at one of the locations. Transportation receptacles may be positioned at the sorter locations and an item may be placed in one of the transportation receptacles. An item may be diverted by diverting the one of the transportation receptacles at the machine location identification that is referenced to that item.

An item may be tracked from the sorter to the particular one of said processing stations by indexing transportation receptacles that are diverted to the particular one of processing stations. Transportation receptacles may be positioned on the sorter by inducting empty transportation receptacles from the processing stations to empty sorter locations not having one of the transportation receptacles at the location. The sorter may be a carrousel sorter and the sorter locations may be cells of the sorter. The sorter cells may be cross belts or tilt trays.

The processing stations may be put walls and an item combined with an order by illuminating a lamp at a location on the put wall corresponding to the order for that item.

The processing stations may be positioned at multiple elevations. The item identification may be referenced with the machine location identification in memory of a computer system.

An order fulfillment method and order fulfillment system, according to another aspect of the invention, includes picking items from inventory according to orders for the items and placing the picked items into picked receptacles. The picked receptacles are forwarded to a sorter having sorter locations. Each of the sorter locations has a unique machine location identification. Items are placed from the picked receptacles to the sorter at one of the locations and an item identification for the item is referenced with the machine location identification of the location at which that item is placed on the sorter. The item at a particular one of the machine locations is diverted to a particular one of a plurality of processing stations according to an order for the item that is at that machine location. The item at that particular one of the machine locations is diverted to that particular one of a plurality of processing stations. The diverted item is combined with the order for that item at the processing station.

The combining of an item with an order may include identifying the item at the processing station and matching that item with the order according to the item identification. The identifying of the item may include scanning an optical code on the item. Items may be placed to the sorter by inducting items with at least one induct to said machine locations. Certain items may be placed in one of a plurality of transportation receptacles prior to inducting that item. The transport receptacles do not need to bear unique receptacle identifiers.

An item may be tracked from the sorter to the particular one of the processing stations. The tracking may include diverting an item to a particular one of a plurality of sorting lanes leading from the sorter to the particular one of said processing stations. The tracking may include producing an indication at the sorting lane of a particular order to combine an item with. The combining is done at the particular one of the processing stations. An indicator may be provided at each of the sorting lanes and an indication provided at one of the lanes along with a corresponding indication at a location at the processing station. In this manner, multiple operators can operate at the particular one of said processing station. The indication may be processed by display screen directed placement, alphanumeric display directed placement and/or voice directed placement.

Empty transportation receptacles may be transported from the processing stations to the induct(s). The sorter may be a circular sorter and the sorter locations being cells of the sorter. The sorter cells may be cross belts or tilt trays. The processing stations may be put walls with multiple unique order locations. An item may be combined with an order by directing an operator to a specific one of the order locations on the put wall corresponding to the order for that item. The sorter may have multiple sorting portions that are positioned at multiple elevations. The sorter may be capable of bidirectional divert at each of the sorting portions. A plurality of induction sections may each be made up of at least one induct that is adapted to induct items to the sorter. Each of the induction sections may be upstream of one of the sorting portions.

An order fulfillment method and system, according to yet another aspect of the invention, includes picking items from inventory according to orders for the items and placing the picked items into picked receptacles. Each of the picked receptacles is forwarded to one of initial processing stations. Items are staged from the picked receptacle at the one of the initial processing stations into initially staged receptacles, each being associated with one of secondary processing stations. Each of the initially staged receptacles is forwarded to the one of the secondary processing stations associated with that initially staged receptacle. Each item is sorted from the initially staged receptacle associated with the one of said secondary processing stations to an order for that item at that one of the secondary processing stations.

The initial processing station may be an initial put wall and items staged from the picked receptacle by sorting items from a picked receptacle to the initially staged receptacles at the initial put wall. The items that may be staged from the picked receptacle include scanning an optical code on each of the items and providing an indication of which initially staged receptacle is to receive the scanned item. Items in each of said initially staged receptacles may include a unique identification and a data processing system that associates the unique identification of each staged receptacle with the secondary processing station to which that one of the staged receptacles is to be directed.

A particular one of the initially staged receptacles may be forwarded when that initially staged receptacle is full or when the one of said secondary processing stations associated with that one of the initially staged receptacles is in need for additional items for processing. A common receptacle set may be used as picked receptacles and initially staged receptacles. One or more of the secondary processing stations may be disabled when a volume of items being put into said initially staged receptacles falls below a particular rate.

Initially staged receptacles may be forwarded to a sorter and diverted with the sorter to associated ones of the secondary processing stations. The sorter may be made up of a plurality of pop-up diverters, right angle transfers or steerable wheel diverters. Each of the secondary processing stations may include a secondary put wall and each item from the initially staged receptacle associated with that secondary processing station is put to a location on that secondary put wall at which the order including that item is being collected. An optical code on each of the items from that initially staged receptacle may be scanning and an indication provided of which location on that secondary put wall is to receive the scanned item.

The item identification may be referenced with the machine location identification in memory of a computer system.

These and other objects, advantages and features of this invention will become apparent upon review of the following specification in conjunction with the drawings.

### BRIEF DESCRIPTION OF THE DRAWINGS

FIG. 1 is a process flowchart illustrating a method of order fulfillment, according to an embodiment of the invention;

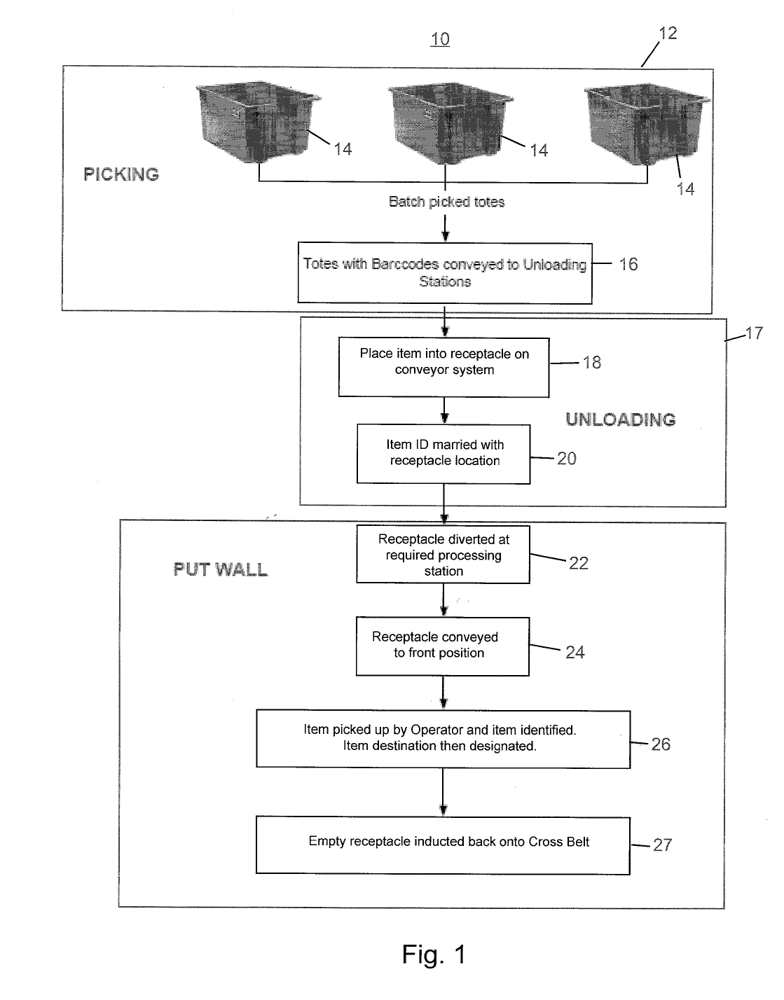

FIG. 2 is a plan view of a portion of an order fulfillment system that is useful with the invention;

FIG. 3 is a plan view of another portion of the order fulfillment system in FIG. 2;

FIG. 4 is an elevation view of the order fulfillment system in FIGS. 2 and 3;

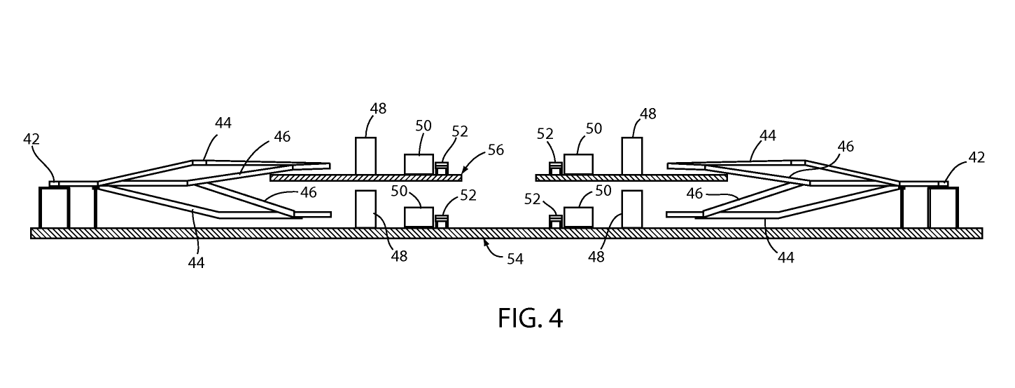

FIG. 5 is a process flowchart illustrating a method of order fulfillment, according to alternative embodiment of the invention;

FIG. 6 is a plan view of an order fulfillment system that is useful with the embodiment of the invention in FIG. 5;

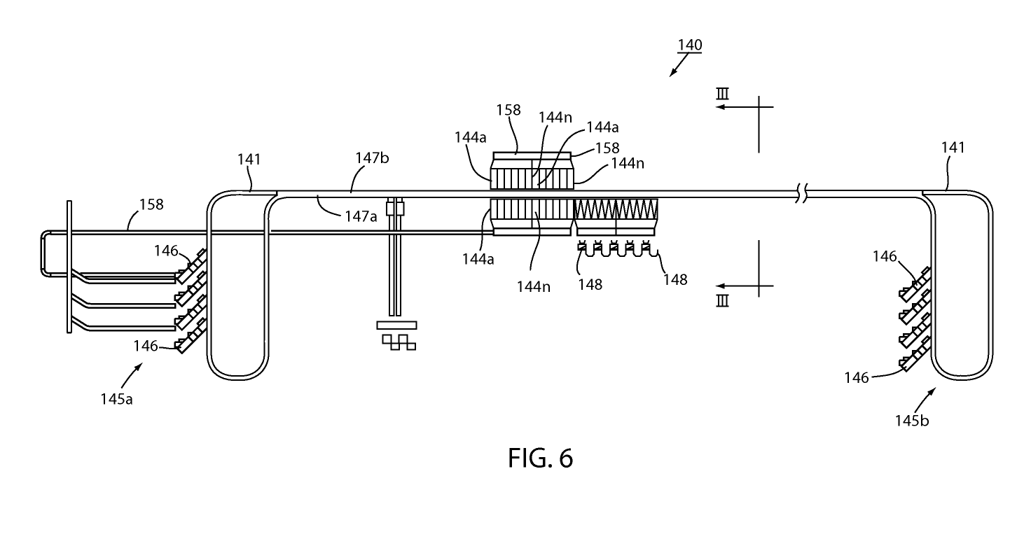

FIG. 7 is an elevation view of the order fulfillment system in FIG. 6;

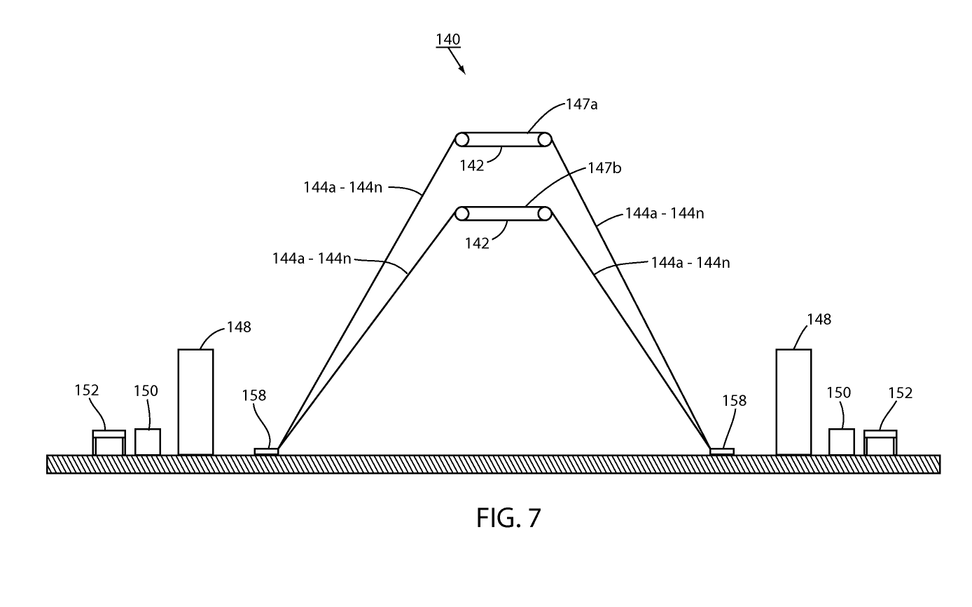

FIG. 8 is the same view as FIG. 6 of an alternative embodiment thereof;

FIG. 9 is a process flowchart illustrating a method of order fulfillment, according to another alternative embodiment of the invention; and

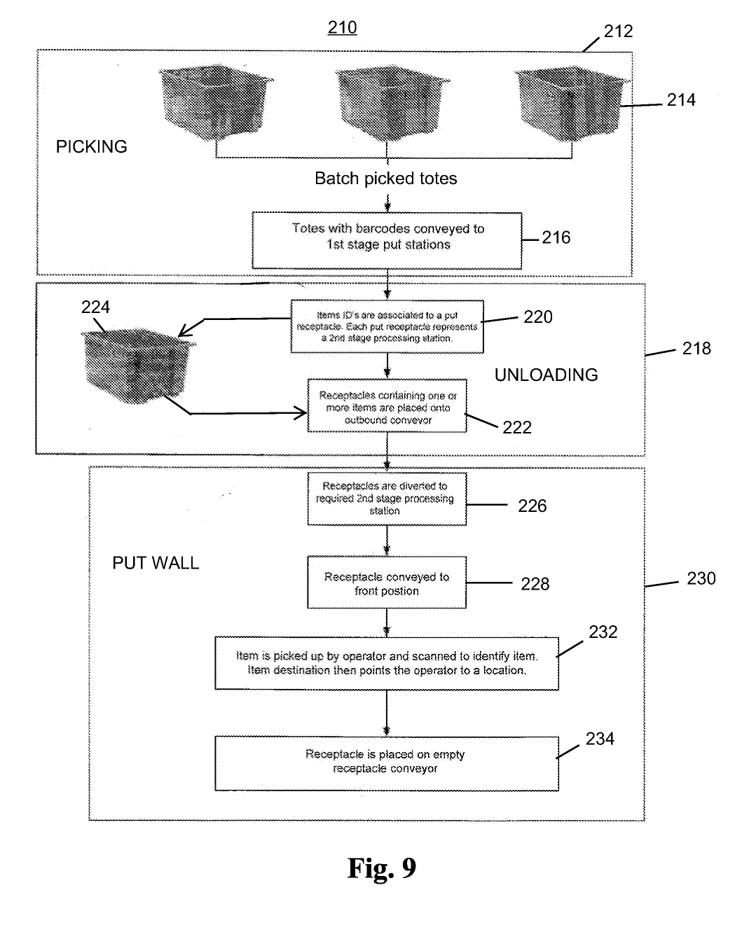

FIG. 10 is a plan view of an order fulfillment system that is useful with the embodiment of the invention in FIG. 9.

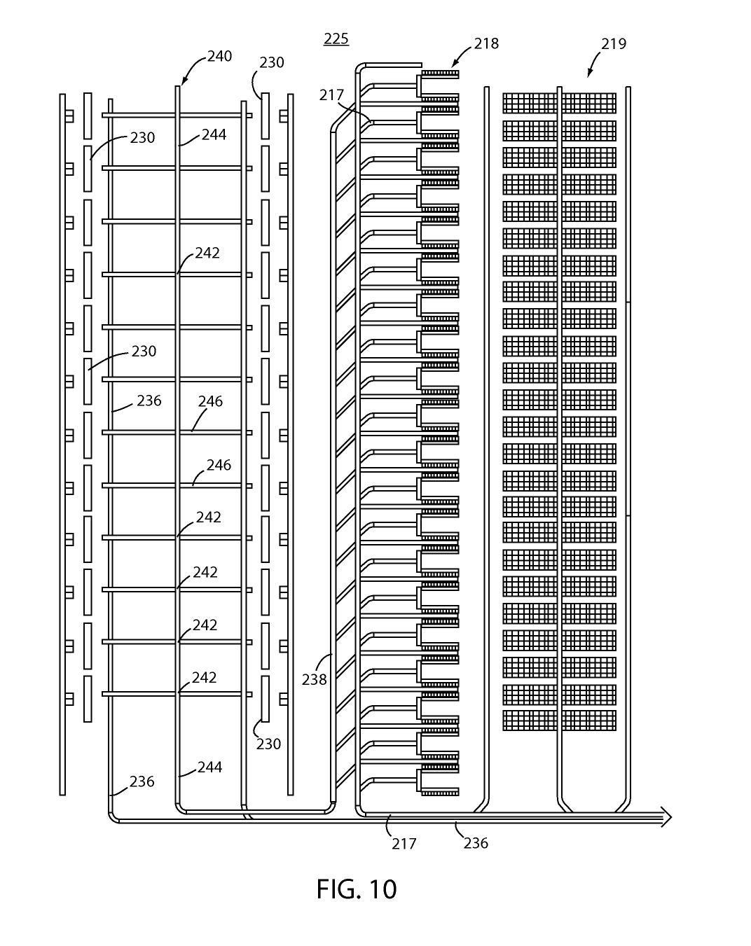

### DESCRIPTION OF THE PREFERRED EMBODIMENT

Referring now to the drawings and the illustrative embodiment depicted therein, an order fulfillment method 10 includes picking items at 12 from inventory according to orders for the items and placing the picked items into picked receptacles 14. Each picked receptacle 14 may be a tray, tote, container, or the like. It is common for the picked receptacles 14 to bear an identification, such as a bar code or RFID tag, in order to uniquely identify the picked receptacle and the identities of the SKUs that are contained therein. Picked receptacles 14 are then forwarded at 16, such as by a conveyor or other material-handling technology to an unloading station 17. Unloading station 17, in the illustrated embodiment, is associated with a sorter 40. Sorter 40 has a transportation line 42 made up of a large number of locations each of which bears a unique machine location identification. At unloading station 17, the items in a picked receptacle 14 are unloaded and positioned at 18 at a particular location on line 42 of sorter 40. If sorter 40 is a carousel sorter, such as a tilt-tray sorter or cross-belt sorter, the item is positioned at a sorter cell, such as a particular tray or cross belt.

Items that are placed at 18 at a particular location of sorter 40 are identified, such as by scanning the bar code or RFID tag of the item, by recognizing the item with a vision recognition system, or the like. Items placed at 18 from picked receptacles to the sorter at one of such locations are then referenced or married at 20 with the machine location identification of the location at which that item is placed on sorter 40. As is known in the art, sorter 40 has a unique identification for each location of the sorter to allow sorter control to identify the time when it is to discharge an item from the sorter. This allows the sorter control to discharge the desired item to the desired destination. In method 10, the warehouse management system (not shown) is aware of the identity of each item being carried by sorter 40 because the item is identified and placed on the sorter at the location of the sorter that passes by unloading station 17 as the item is being scanned. This is possible if the sorter has an induct. Alternatively, as will be discussed below, this may be accomplished if the sorter is operated at a slow enough speed that allows the operator to scan and position the item directly to a sorter location, namely, an unoccupied sorter location.

Because the identification of the item placed at 18 is married to the unique machine location identification of the location of sorter 40 at which the item is placed at 20, the warehouse management system can instruct sorter 40 to divert at 22 the item at that machine location identification to a particular one of a plurality of processing stations, such as a put wall station 48, where the order including that item is being assembled, such as by combining the item with other items of the order. A discharge line 44 conveys at 24 the diverted item to a position in front of an operator. The operator then combines the item with the order at 26, as will be discussed in more detail below. In the illustrated embodiment, transportation trays are used to transport items from unloading station 17 to a processing station, such as put wall 48. Such transportation trays do not need to have a unique identification code, but are, rather, used to ensure that each item can be conveyed by sorter 40 regardless of the characteristics of that item. The transportation receptacle is then inducted back onto sorter 40 at 27 using an induction line 46.

Various techniques may be used to allow the operator at put wall 48 to combine the item diverted from sorter 40 to a particular order. One technique is to have the operator identify the item when it is removed from the transportation receptacle. This may be accomplished by the operator scanning an optical code, RFID tag or the like on the item. This will cause an indication to the operator of where the order incorporating that item is being assembled. For example, a light or other indicator may be illuminate on put wall 38. Another technique is to track the item from the sorter to the put wall and cause a light to illuminate on put wall 38. This is possible because the warehouse management system has married the identity of the item with the machine location identification from which that item was diverted. By keeping track of the passage of receptacles being transported to put wall 38, the warehouse management system is able to track the item to the put wall and to illuminate the light for the location where the order incorporating that item is being assembled. If is desired to ensure that the tracking of the receptacles is accurate, the warehouse management system may display an image of the item corresponding to that order. This allows the operator to verify that the desired item is being presented to the put wall. If the item being conveyed to the put wall at 24 does not match that of the image being displayed, the operator may then scan the optical code on the item which should then cause the warehouse management system to match that item with the associated order and illuminate the light associated with the location where that order is being assembled.

Transportation receptacles may be continuously recirculated between put walls 48 and sorter 40. This may be accomplished in a manner that empty transportation receptacles are already positioned on sorter 40 at the unloading station 17. In this manner, the operator can place an item onto sorter 40 at 18 and marry the identification of the item with the machine location identification at 20 by scanning the item at unloading station 17 and placing the item into an empty transportation receptacle passing by the unloading station. An item can be diverted from sorter 40 at 22 by diverting the transportation receptacle at that machine location. If it is desired to track the item from the sorter to put wall 48, this may be accomplished by maintaining an index of transportation trays travelling from the sorter to a particular put wall. Not only do transportation trays ensure that virtually all items can be handled by sorter 40, regardless of their physical characteristics, but that items discharged from sorter 40 will stay in a single line between the sorter and the put wall to avoid items getting out of sequence.

Fulfillment system 39 includes discharge lines 44 to convey at 24 the discharged transportation receptacles discharged from sorter 40 to the particular put wall. Adjacent each discharge line 44 is an induction line 46 to allow the emptied transportation receptacles to be re-inducted to sorter 40. As is known in the art, induction technology for cross-belt or tilt-tray sorters allows items to be inducted to unoccupied belts or trays 42. As such, each induction line 46 is capable of re-inducting emptied transportation receptacles to unoccupied belts or trays of line 42 and line 42 conveys the empty transportation receptacles to unloading station 17 where items are placed into the empty trays as previously described.

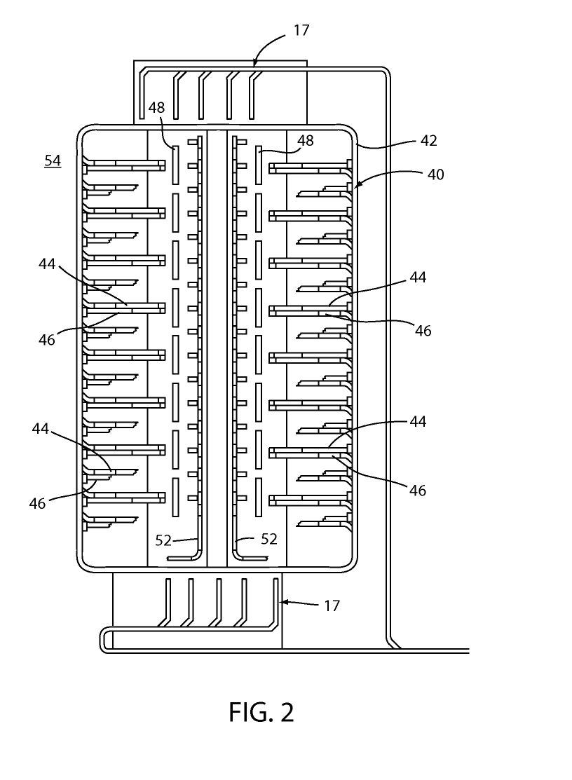

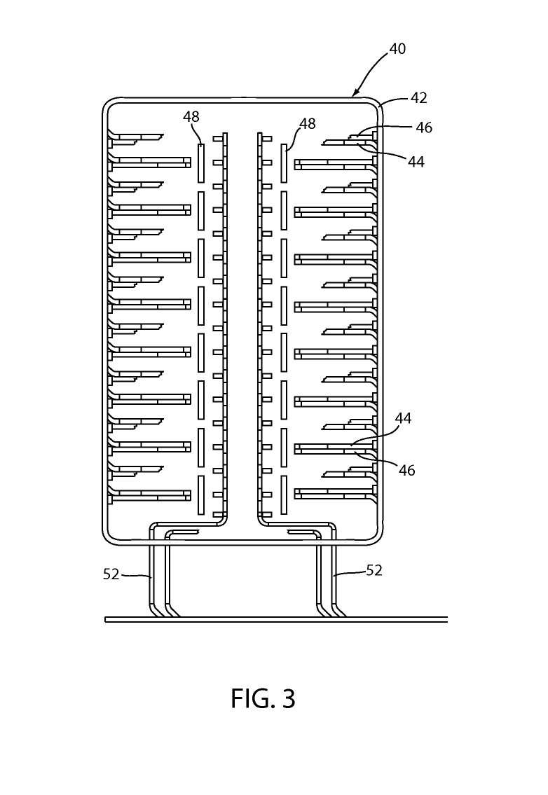

A pack-out table 50 may be provided behind each put wall 48 opposite to the location of the put operator. When the order is packed at pack out table 50, it can be placed on a completed order conveyor 52 for further processing, such as gift-wrapping or shipping. In the illustrated embodiment, put walls 48 are located at a lower level 54, as seen in FIG. 3, or an upper level 56, as seen in FIG. 2. Although sorter 40 is seen in both views, it should be understood that only one sorter is used. Of course, it would be possible to have more than one sorter or to have all of the put walls on one level. Also, although put walls are shown as positioned on one side of line 42, it would be possible to have them arranged at opposite sides so that sorter 40 discharges either to the left or right. Also, it may be possible to have more than one discharge line 44 for each put wall. If more than one discharge line is used per put wall, it may be possible to sort the items into orders or partial orders and it may be possible to have more than one operator operating at a put wall. If more than one operator is used or if multiple chutes are employed, it may be useful to have colored lights at the put wall to distinguish between operators and/or orders.

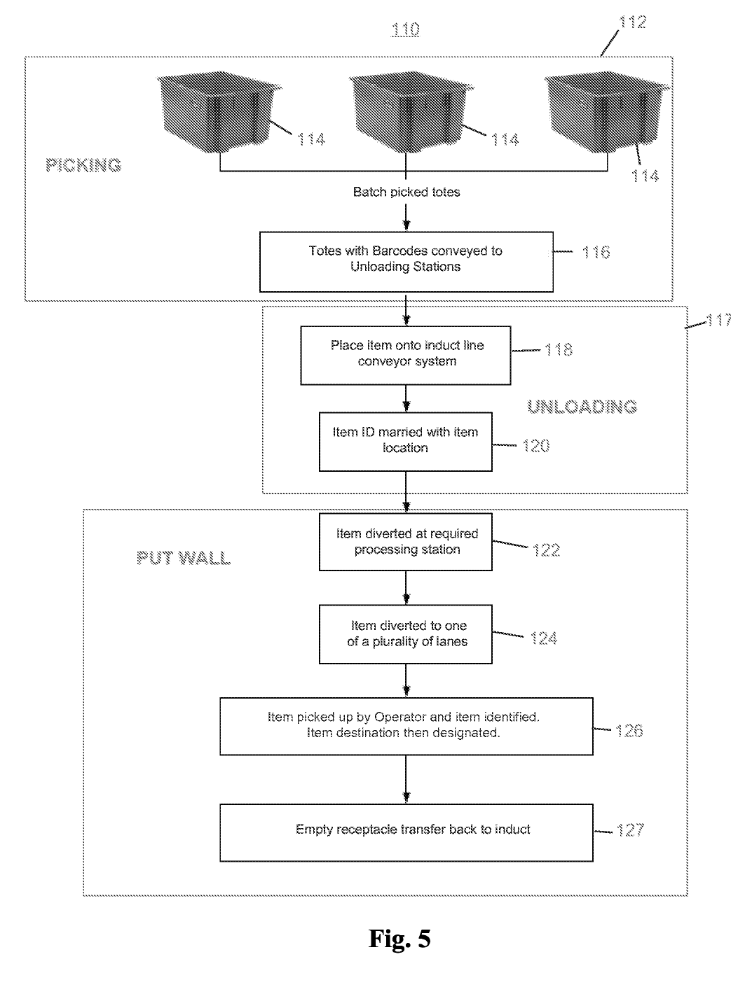

According to an alternative embodiment, an order fulfillment method 110 includes picking items at 112 from inventory according to orders for the items and placing the picked items into picked receptacles 114 (FIG. 5). Each picked receptacle 114 may be a tray, tote, container, or the like. It is common for the picked receptacles 114 to bear an identification, such as a bar code or RFID tag, in order to uniquely identify the picked receptacle and the identities of the SKUs that are contained therein. Picked receptacles 114 are then forwarded at 116, such as by a conveyor or other material-handling technology to an unloading station 117. A wave buffering step (not shown) may be provided either as a part of or before conveying step 116. Unloading station 117, in the illustrated embodiment, is associated with a sorter 140. Sorter 140 has a transportation or conveyor line 141 made up of a large number of locations 142, each of which bears a unique machine location identification. At unloading station 117, the items in a picked receptacle 117 are unloaded and positioned at 118 at a particular location 142 on line 141 of sorter 140. If sorter 140 is a carousel sorter, such as a tilt-tray sorter or cross-belt sorter, the item is positioned at a sorter cell, such as a particular tray or cross belt which defines location 142.

Items that are placed at 118 at a particular location 142 of sorter 140 are identified, such as by scanning the bar code or RFID tag of the item, by recognizing the item with a vision recognition system, or the like. Items placed at 118 from picked receptacles to the sorter at one of such locations are then referenced or married at 120 with the machine location identification of the location at which that item is placed on sorter 140. As is known in the art, sorter 140 has a unique identification for each location 142 of the sorter to allow sorter control to identify the time when it is to discharge an item from the sorter. This allows the sorter control to discharge the desired item to the desired destination. In method 110, the warehouse management system (not shown) is aware of the identity of each item being carried by sorter 140 because the item is identified and placed on the sorter at the location of the sorter that passes by unloading station 117 as the item is being scanned. This is possible if the sorter has one or more induction sections 145a, 145b each made up of one or more induct lines 146. As is known in the art of circular sorters, the machine control is capable of monitoring the availability status of each machine location 142, such as a cross belt or tilt tray, and to induct an item from a particular one of induct lines 146 and to position that item to the available machine location.

Because the identification of the item placed at 118 is married to the unique machine location identification of the location 142 of sorter 140 at which the item is placed at 120, the warehouse management system can instruct sorter 140 to divert at 122 the item at that machine location identification to a particular one of a plurality of processing stations, such as a put wall station 148, where the order including that item is being assembled, such as by combining the item with other items of the order. Not only is the item diverted to a particular processing station at 122 but the item is diverted at 124 to one of a plurality of discharge lanes 146a . . . 146n leading from the sorter to an operator position at the particular processing station 148. The operator then combines the item with the order at 126, as will be discussed in more detail below.

In the illustrated embodiment, some items are capable of being transported by sorter 140, with such items being referred to as conveyable items. Other items due to their size, shape, lack of rigid lower surface or other physical characteristic are deemed not capable or desirable to be transported by sorter 140, with such items being referred to as being non-conveyable. Transportation receptacles are available to use to transport non-conveyable items from unloading station 117 to a processing station, such as put wall 148. Such transportation receptacles do not need to have a unique identification code, but are, rather, used to ensure that each item can be conveyed by sorter 140 notwithstanding the physical characteristics of that item. The identification of each item is married with a unique machine location on sorter 140 whether the item is conveyable or non-conveyable and conveyed in one of the transportation receptacles. The transportation receptacle is then transferred back at 127 to an induction line 146. A return line 158 may be used to convey the empty transportation receptacles from the processing station to induction lines 146, particularly if it is deemed that a significant number of items will be non-conveyable and thereby requiring a transportation receptacle on sorter 140. Alternatively, the transportation receptacles can be stacked and manually moved from the processing stations 148 to induction lines 146 particularly if it is deemed that only a small number of items are going to be non-conveyable and thereby require transportation receptacles.

Sorter 140 is made up of endless conveying lines 141 made up of a chain of individual crossbelts or tilt trays, each having a unique machine identification, that are conveyed from an induction section 145 made up of induction lines 146 to a sorting section 147 made up of a plurality of discharge lines 144. Discharge lines 144 transfer discharged items from sorting section 147 to one of put walls 148 or other processing station. In the illustrated embodiment, sorter 140 is in the form of a “C” shape when viewed from above made up of two induction sections 145a, 145b and two sorting sections 147a, 147b, one moving from induction section 145a to induction section 145b and the other from induction section 145b to induction section 145a. If induction sections 145a 145b are at the same elevation, one will discharge in one lateral direction and the other will discharge in an opposite lateral direction. One drawback with such arrangement is that an item that fails to be diverted to its intended put wall 148, for whatever reason, will need to make a full revolution around sorter 140 before arriving at the intended put wall 148 again. In the illustrated embodiment, sorting sections 147a, 147b are at different elevations, as best seen in FIG. 3. The advantage of having sorting sections 147a, 147b at different elevations is that each sorting section can discharge in both lateral directions, and bidirectionally. This allows an item that fails to discharge from one of sorting sections 147a, 147b to a particular put wall 148 to be discharged by the other of the sorting section after only travelling half way around conveying line 141, thereby reducing the number of non-sorted items from being present on conveying line 41 thereby providing greater capacity to handle items.

Each processing station, or put wall 148, may be provided with diverted items by a plurality of discharge lines 44a . . . 44n. An indicator, such as a video display, audible signaling device or indicator lights may be used to match an item at one of the discharge lines 44a . . . 44n with a particular order being assigned at put wall 148. This may be accomplished, for example, by providing an indicator light at the operator end of each discharge line 44a . . . 44n that is illuminated at a color that matches the color of an indicator light at a bin in put wall 148. This allows an operator more time to retrieve an item from a discharge line before another item is discharged to that put wall. Alternatively, this allows multiple operators to be used for each put wall 148, each responding to different light colors, or the like. One way of using multiple discharge lines is to program sorter 40 to only discharge to a discharge line 44a . . . 44n if the line is empty and does not contain an item waiting to be retrieved for inclusion in an order.

Alternatively, sorter 140 may be programmed to discharge an item to a discharge line 44a . . . 44n, but requires manual identification of items, such as by using a scanner (not shown) for scanning item codes such as scanning an optical code, RFID tag, or the like, on the item. This will cause an indication to the operator of the unique location on put wall 148 where the order incorporating that item is being assembled. For example, uniquely colored lights or other indicator may be illuminated on put wall 138 at each unique order collection area. Other techniques may be used to associate an item discharged to a discharge line 44a . . . 44n to be identified with an order being assembled at a unique order collection location at put wall 148. The identification may come from display screen directed placement, alphanumeric display directed placement, voice directed placement, or other computer directed methods to inform the operator where the order is being assembled that includes the item being discharged to that processing station.

A pack-out table 150 may be provided behind each put wall 148 opposite to the location of the put operator. When the order is packed at pack out table 150, it can be placed on a completed order conveyor 152 for further processing, such as gift-wrapping or shipping. If provided, return line 158 can be routed past each put wall 148.

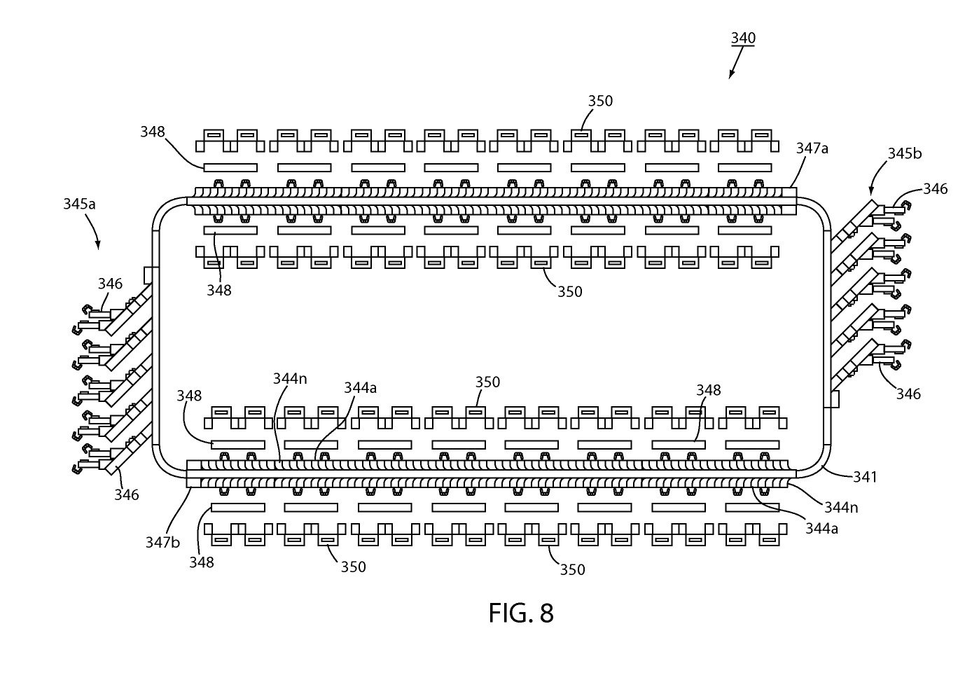

The layout of the sorter may vary depending upon the application. As illustrated in FIG. 8, method 110 may be carried with a sorter 340 that is similar to sorter 140 except that it is made up of endless conveying line 341. Conveying line 341 is made up of a chain of individual crossbelts or tilt trays, each having a unique machine identification, that are conveyed from induction sections 345a, 345b made up of induction lines 346 to sorting sections 347a, 347b. Each sorting section 347a, 347b is made up of a plurality of discharge lines 344a . . . 344n. Discharge lines 344a . . . 344n are conveyors or chutes, or the like, to transfer discharged items from sorting section 347a, 347b to one of put walls 348 or other processing station. In the illustrated embodiment, sorter 340 is in the form of an oval shape when viewed from above made up of two induction sections 345a, 345b and two sorting sections 347a, 347b, one moving from induction section 345a to induction section 345b and the other from induction section 345b to induction section 345a. The crossbelts or tilt trays are capable of bidirectional diverts to put walls 348 located on opposite sides of the conveying line 341.

A pack-out table 350 may be provided behind each put wall 348 opposite to the location of the put operator. When the order is packed at pack out table 350, it can be placed on a completed order conveyor (not shown) for further processing, such as gift-wrapping or shipping. If provided, a transportation receptacle return line (not shown) can be routed past each put wall 348.

In the illustrated embodiment, sorter 340 may have two induction sections 345a, 345b each sorting to 50% of the conveying line such as to sorting section 347a or 347b. Alternatively, each of the two induction sections 345a, 345b could sort to 100% of conveying line 341. Although not illustrated, three induction sections could be provided, each sorting to 33% of conveying line 341. Of course, one induction section could be provided sorting to 100% of the conveying line 341.

According to another alternative embodiment, an order fulfillment method 210 includes picking items at 212 from inventory according to orders for the items and placing the picked items into picked receptacles 214. Each picked receptacle 214 may be a tray, tote, container, or the like. It is common for the picked receptacles 214 to bear an identification, such as a bar code or RFID tag, in order to uniquely identify the picked receptacle and the identities of the SKUs that are contained therein. Picked receptacles 214 are then forwarded at 216, such as by a conveyor 217 or other material-handling technology 225 to an initial processing station 218. A buffer system 219 may be provided to smooth the flow of picked receptacles 214 from picking 212.

Initial processing station 218 is a put facility, such as an initial put wall where an operator processes items from the picked receptacle 214 at that initial processing station 218 into initially staged receptacles 224. This is accomplished by the SKU of each item from the picked receptacle 214 being identified, such as by scanning its bar code, or the like, at 220 and associating that item with a secondary processing station 230. The item is placed into an initially staged receptacle 224 which is associated with one of the secondary processing stations 230 and sent to an outbound conveyor 238 at 222. The item in each receptacle 224 is associated with a secondary processing station 230 by a database on a warehouse management system (not shown). Each initially staged receptacle is matched with a secondary processing station by a reader, such as an optical scanner or RFID reader, which reads the identity of the initially staged receptacle 224 as it is being inputted to initial processing station 218. So, method 210 is able to subsequently ensure that an initially staged receptacle 224 is routed at 226 to the proper secondary processing station 230 by reading the unique identification associated with that receptacle or by otherwise tracking that receptacle. In the illustrated embodiment, the same set of uniquely identified receptacles are used as picked receptacles 214 and as initially staged receptacles 224, once they have been emptied of substantially all items at an initial processing station 218. In the illustrated embodiment, an empty receptacle line 236 may be provided to return initially staged receptacles at 234 that have been emptied of items at a secondary processing station 230 back to picking operation 212. In this manner, one set of uniquely identified receptacles is used throughout method 210. However, it would be possible to have one set of receptacles circulating between picking 212 and initial processing stations 218 and a different set of receptacles circulating between initial processing stations 218 and secondary processing stations 230.

In the illustrated embodiment, each initially processing station 218 is a put wall.

Steps 220 and 222 of processing items each from picked receptacle 214 may include sorting items from that picked receptacle to the desired initially staged receptacles 224, such as by a lamp, digital display, monitor, or the like, which is activated when an item is picked from receptacle 214 and its optical code scanned. The initially staged receptacles are conveyed such as by an initially staged line 238 to a sorter 240 that diverts the initially staged receptacles 224 to the associated secondary processing station 230. Thus, steps 220 and 222 of processing items from the picked receptacle 214 may include scanning an optical code on each of the items and providing an indication of which initially staged receptacle is to receive the scanned item.

Items placed in each of the initially staged receptacles 224 at initial processing stations 218 may include a unique identification. A data processing system (not shown) associates the unique identification of each of the initially staged receptacles 224 with the secondary processing station 230 to which that one of the initially staged receptacles is to be directed. A particular one of the initially staged receptacles may be discharged from initial processing station 218 and forwarded to sorter 240 when that initially staged receptacle is full or when the secondary processing station 230 associated with that one of the initially staged receptacles 224 is in need of additional items for processing, i.e., is starved of items to sort to orders.

Another buffer system (not shown) may be provided between initial processing stations 218 and secondary processing stations 230. Orders assigned to a secondary processing station may be picked before the station is ready to receive the items. This may occur because orders are grouped into batches or waves. If picked receptacles have completed the picking process before the secondary processing stations are ready to receive the items, such additional buffering can temporarily hold the initially staged receptacles until the secondary processing stations are ready to receive the items. Method 210 may further include disabling one or more secondary processing stations 230 when a volume of items being put into said initially staged receptacles falls below a particular rate. This may occur during the overnight hours. Alternatively, if the picking system is sized to handle the surge in traffic that occurs about certain holidays, then secondary processing stations 230 may be disabled when volume is not at peak. Sorter 240 includes diverters 242 each capable of diverting the initially staged receptacles 224 from a main line 244 to a conveyor 246 leading to one of the secondary processing stations 230. Diverters 242 may be selected from pop-up diverters, right-angle transfers, steerable wheel diverters, or the like. While a higher capacity sorter may be used, such as a shoe and slat sorter or a carrousel sorter, sorter 240 is capable of handling the flow of initially staged receptacles at a lower installed cost. Each receptacle 224 will, in turn, reach the front position 228 as receptacles 224 in front of it are emptied.

In the illustrated embodiment, secondary processing stations 230 are each a put wall of the type known in the art. Each item from the initially staged receptacle 224 is sorted from that initially staged receptacle to a location on that put wall at which the order including that item is being collected. This may be accomplished by scanning an optical code at 232 on each of the items picked from an initially staged receptacle 224 and providing an indication, such as by illuminating a lamp, digital display or other monitor of which location on that put wall is to receive the scanned item. The empty receptacle is then placed at 234 on empty receptacle line 236 or diverted to the line.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. An order fulfillment method, comprising:
picking items from inventory according to orders for the items and placing the picked items into picked receptacles;
forwarding the picked receptacles to an unloading station and placing items into transport receptacles;
identifying an identifier of each item at the unloading stating and marrying the identifier of the item with the transport receptacle into which the item is placed;
tracking transport receptacles from the unloading station according to the identifier of the item in that transport receptacle and movement of the transport receptacle;
diverting the transport receptacle to a particular one of a plurality of processing stations according the identifier of the item in that transport receptacle and an order for the item; and
combining each item with an order for that item at the particular processing station.

2. An order fulfillment method, comprising:
picking items from inventory according to orders for the items and placing the picked items into picked receptacles;
forwarding the picked receptacles to a sorter having sorter locations, each of said locations having a unique machine location identification;
placing items from said picked receptacles to said sorter at one of said locations and referencing an item identification with the machine location identification of the location at which that item is placed on the sorter;
diverting the item at a particular one of said machine locations to a particular one of a plurality of processing stations according to an order for the item that is at that machine location by selecting that item to be diverted according to machine location identification; and
combining the item with the order for that item at the processing station.

3. An order fulfillment method, comprising:
picking items from inventory according to orders for the items and placing the picked items into picked receptacles;
forwarding each of the picked receptacles to one of initial processing stations;
processing items from the picked receptacle at the one of said initial processing stations into initially staged receptacles, each of the initially staged receptacles being associated with one of secondary processing stations;
forwarding each of the initially staged receptacles to the one of said secondary processing stations associated with that initially staged receptacle; and
processing each item from the initially staged receptacle associated with the one of said secondary processing stations to an order for that item at that one of said secondary processing stations.
